(19) United States
(12) Patent Application Publication
(10) Pub. No.: US 2006/0046126 A1
(43) Pub. Date: Mar. 2, 2006

(54) Fuel cell and information terminal carrying the same

(76) Inventors: Osamu Kubota, Hitachi (JP); Tomoichi Kamo, Naka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/211,654

(22) Filed: Aug. 26, 2005

(30) Foreign Application Priority Data
Aug. 26, 2004 (JP) 2004-246073

(51) Int. Cl. H01M 8/00; H01M 2/02

(52) U.S. Cl. 429/34; 429/33; 429/12

(57) ABSTRACT

A fuel cell, which comprises a plurality of fuel cell units each comprising an anode for oxidizing fuel, a cathode for reducing oxygen, an membrane/electrode assembly sandwiched between the anode and the cathode, wherein the fuel cell units are arranged in a plane to constitute power generation unit, a plurality of the power generation unit being stacked by means of insulating plates. The disclosure is also concerned with an information terminal mounting the fuel cell.

### CLAIM OF PRIORITY

This application claims of priority from Japanese application serial No. 2004-246073, filed on Aug. 26, 2004, the content of which is hereby incorporated by reference into this application.

### DESCRIPTION OF THE INVENTION

1. Field of the Invention

The present invention relates to a fuel cell, and more particularly to a direct methanol fuel cell (DMFC), which is suitable for a power source of mobiles. The fuel cells are of a small thickness and high energy density.

2. Related Art

Recently, portable information terminals such as notebook type personal computers, PDA (personal digital assistant), mobile phones have been developed and widely used. These information terminals have a technical target how to make its power source small and compact.

There are two types of power sources for the mobiles, one of which is a polymer electrolyte type fuel cell (PEFC), constituted as a laminated type, and the other of which is a direct methanol fuel cell (DMFC), constituted as a panel type cell. The polymer electrolyte type fuel cell directly converts chemical energy of hydrogen to electric energy without causing combustion process. Since the polymer electrolyte type fuel cell generates electricity by using hydrogen, a hydrogen tank is needed, which leads to enlargement of its size. Accordingly, the PEFC is not suitable as a power source for the mobiles.

On the other hand, the direct methanol fuel cell uses a solid polymer electrolyte membrane and directly generates electricity from methanol. The performance of the DMFC greatly depends on temperature. Activity of methanol oxidation reaction at an electrode is high when the operating temperature is as high as 80 to 100° C., for example. But, if the activity is kept at room temperature, DMFC may be used for the mobiles such as notebook type personal computers, portable phones, etc.

Batteries used for the mobiles should provide electric power, which can drive the mobiles such as notebook PCs, mobile phones, etc. If fuel cells are used for the notebook PCs or mobile phones for producing necessary power, the size of the fuel cells will become large. Since the fuel cells generate direct current, the voltage increases in accordance with the number of stacked unit cells. That is, the fuel cells must be constituted by stacking unit cells to produce a large power. Accordingly, the size of the fuel cell will become large, which is not suitable for the notebook PCs or mobile phones.

Conventional polymer electrolyte type fuel cells (PEFC) constituted as a stacked type fuel cell are difficult to be downsized; this type of fuel cells are not suitable for the notebook PCs or mobile phones. Panel type direct methanol fuel cells (DMFC) are superior to PEFC in downsizing, which may be employed for the notebook PCs or the mobile phones.

In the case of the notebook PCs or the mobile phones, users want light-weight and downsizing; if the size of the devices that use fuel cells becomes large, the fuel cells are not employed as a power source for the PCs or the mobile phones. Recently, employment of DMFC as the power source for PCs or mobile phones has been investigated.

However, though the conventional DMFCs, which are formed into panels are proper for thin type cells, it was difficult to obtain a high energy density. Thus, the panel type cells were stacked to produce a necessary electric power as disclosed in patent document No. 1. The patent document No. 1 discloses a number of separators 8 and cells are stacked in the direction of the thickness.

Patent document No. 1: Japanese patent laid-open 08-17451 (page 5, FIG. 11)

However in the patent document No. 1, since a large number of separators 8 and cells I are stacked, it is difficult to obtain a thin-stacked fuel cell. Therefore, the stacked fuel cell is not proper for a power source of PCs or mobile phones.

### SUMMARY OF THE INVENTION

One of the objects of the present invention is to provide a fuel cell having a separator for a thin type fuel cell that can generates a sufficient output and can be thinned and light-weighted.

Another object of the present invention is to provide a mobile information terminal with a fuel cell having a separator for a thin type fuel cell, which can realize more light-weight and thinner than the conventional fuel cells.

A fuel cell of the present invention comprises stacked generation units each comprising a plurality of unit cells each of which comprises a membrane/electrode assembly having an anode for oxidizing fuel, a cathode for reducing air and an electrolyte membrane sandwiched between the electrodes, wherein the unit cells are arranged in plane to constitute each of the power generation units.

The present invention provides a mobile information terminal such as a notebook PC, PDA, mobile phone, etc, on which a fuel cell is mounted, wherein the fuel cell comprises stacked power generation units each comprising a plurality of unit cells each of which comprises a membrane/electrode assembly having an anode for oxidizing fuel, a cathode for reducing air and an electrolyte membrane sandwiched between the electrodes, wherein the unit cells are arranged in plane to constitute each of the generation units.

According to the fuel cell of embodiments of the present invention, it is possible to provide a small sized, compact fuel cell power source, which is particularly used for mobile phones, personal information terminals, notebook PCs, etc that have strongly demanded downsizing and thinning of power sources. The fuel cell of the invention has high energy density and is capable of continuous generation of power without charging operation, wherein fuel is easily supplied by exchanging a fuel cartridge tank.

The information terminal that installs the fuel cell of the invention is more light-weighted and downsized than the conventional fuel cell mounted information terminals.

### BRIEF DESCRIPTION OF THE DRAWINGS

FIG. 1 is a diagrammatic exterior view of a fuel cell system of the present invention.

FIG. 2 is a perspective view of a fuel cell of the present invention.

FIGS. 3(A) and 3(B) are a plan view and a cross sectional view of a bipolar plate, respectively.

FIGS. 4(A) to 4(C) are plan views of current collectors.

FIGS. 5(A) and 5(B) are a plan view and a cross sectional view of a separator, respectively.

FIG. 6 is a plan view of an end plate for the fuel cell according to the present invention.

FIGS. 7(A) and 7(B) are cross sectional view along line A-A in FIG. 6 and a cross sectional view along line B-B in FIG. 6, respectively.

FIGS. 8(A) and 8(B) are a plan view and a cross sectional view of an MEA for the fuel cell according to the present invention.

FIGS. 9(A) and 9(B) are a plan view and a cross sectional view of a gasket for the fuel cell according to the present invention.

FIGS. 10(A) and 10(B) are a plane view of an anode diffusion layer and a plan view of a cathode diffusion layer, respectively.

FIG. 11 is a developed view of the fuel cell according to the present invention.

FIGS. 12(A) and 12(B) are a plan view and a cross sectional view of a separator of another embodiment, respectively.

FIGS. 13(A) and 13(B) are a plan view and a cross sectional view of still another embodiment, respectively.

### DETAILED DESCRIPTION OF THE PREFERRED EMBODIMENTS

The direct methanol fuel cell according to the embodiments of the present invention comprises a plurality of power generation units each having a plurality of unit cells arranged in a plane, the power generation units being stacked by means of a separator and being electrically connected with each other to constitute a stacked fuel cell. The unit cells in the plane may be electrically connected in series. The stacked power generation units may be electrically connected in series, too.

The conventional stacked type fuel cells were difficult to construct thin compact structures, while a high power output is demanded. The conventional thin fuel cells in which unit cells are arranged in a plane can be thin but is difficult to make an area small. The fuel cell of the present invention can be drastically thin, although it performs as a high power output fuel cell.

The information terminals are realized by mounting the fuel cell of the present invention on the terminals. That is, the information terminals comprises a mobile electronic device and a fuel cell, which comprises a plurality of power generation units each having a plurality of unit cells arranged in a plane, the power generation units being stacked by means of a separator or separators and being electrically connected with each other to constitute a stacked fuel cell. The unit cells in the plane may be electrically connected in series. The stacked power generation units may also be electrically connected in series. The information terminals include notebook type personal computers, PDA, mobile phones, etc.

### Embodiment 1

In the following, the fuel cell according to the present invention will be explained in detail.

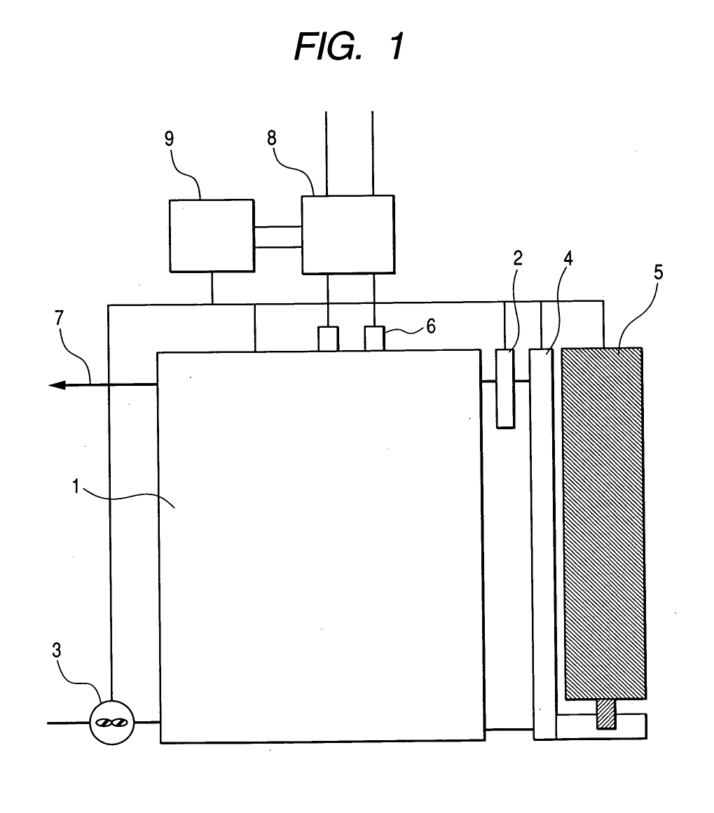

FIG. 1 shows a diagrammatic view of a fuel cell system according to the present invention. In this embodiment, a direct methanol type fuel cell, which employed a separator for a thin type fuel cell will be explained.

In FIG. 1, a power generation system using the fuel cell of the present invention comprises a fuel cell 1, a micro-pump 2 for circulating fuel in the fuel cell, a micro blower 3 for supplying air into the fuel cell, a fuel circulation tank 4, a fuel cartridge tank 5 and a gas discharge port 7. The micro-pump 2 sends out the fuel (methanol aqueous solution) stored in the fuel circulation tank 4 to the fuel cell at a constant pressure. The micro-blower 3 supplies air as an oxydant to the fuel cell at a constant pressure. The fuel circulation tank 4 stores the fuel to be supplied to the fuel cell with the micro-pump 2. The fuel cartridge tank 5 is an exchangeable container for containing the fuel.

The fuel cartridge 5 is provided with a fuel sensor for detecting an amount of fuel in the cartridge tank 5. The sensor output signals on the fuel amount. The fuel circulation tank 4 is provided with a fuel storage amount sensor for detecting a temporally storage amount of the fuel. The fuel storage amount sensor outputs signals on a temporally storage amount detected by the sensor.

The fuel cell system employs a system in which electric power is supplied to a load (not shown) by means of a DC/DC converter 8, which outputs signals on the status during operation and stoppage of the fuel cell. A power terminal 6 for outputting electric power and a gas discharge port 7 discharges produced gas (CO₂).

The signals from the sensors, etc are input into a controller 9, which outputs signals upondemands. The fuel cell system comprises the micro-pump 2, the micro-blower 3, the fuel circulation tank 4, the fuel cartridge tank 5, the power terminal 6, the gas discharge port 7, the DC/DC converter 8 and the controller 9.

The controller 9 controls an amount of fuel circulation by the micro-pump 2 and controls an amount of wind by the micro-blower 3 in accordance with changes of load on the fuel system so that stability of the power source voltage is assured. The controller 9 further controls to keep the temperature of the fuel cell to a predetermined value. If necessary, it displays the operation condition of the power source on the load apparatuses.

Further, if a residual amount of the fuel in the fuel cartridge tank 5 or in the fuel circulation tank 4 becomes smaller than a predetermined value or an amount of wind supplied by the micro-blower 3 is outside the predetermined value, the controller 9 stops supply of the electric power to the load and drives an alarm means for outputting an alarm such as sounds, voices, pilot lamps, characters, etc. The controller 9 causes the load apparatuses display an amount of the fuel in response to the fuel circulation tank 4 and the fuel cartridge tank 5 during the normal operation of the fuel cell system.

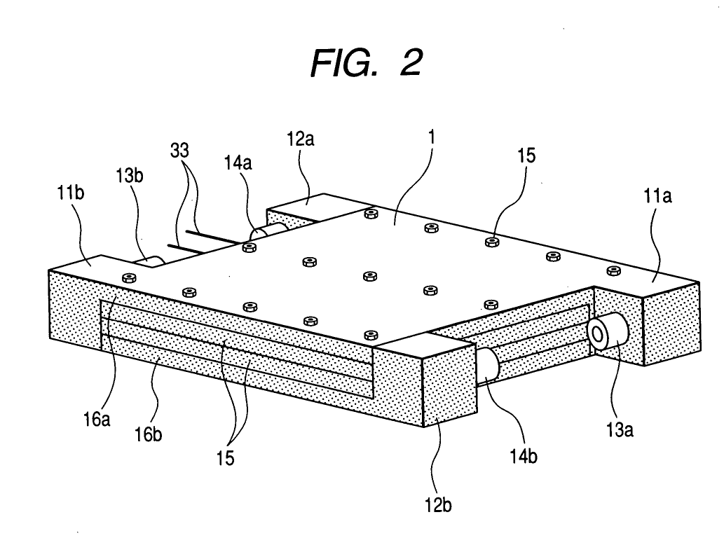

FIG. 2 is a perspective exterior view of the fuel cell 1 according to the present invention. In FIG. 2, 11a and 11b are portions where fuel supply manifolds are disposed inside. 12a and 12b are portions where air supply manifolds are disposed. 13a is a fuel supply port, 13b is a fuel discharge port, 14a is an air supply port, 14b is an air discharge port, 15 denotes separators, 16a and 16b are end plates and 33 denotes output terminals.

The fuel supply manifolds disposed at 11a, 11b, which are branched tubes for supplying the fuel (methanol aqueous solution) to the separators 15. The air supply manifolds disposed at 12a, 12b are branched tubes for supplying air to the separators 15.

The fuel supply port 13a supplies the fuel to the separators 15 from the fuel cartridge tank 5 through the fuel circulation tank 4. The fuel discharge port 13b returns the fuel, which was not consumed (residual fuel of the reaction with air), to the fuel circulation tank 4 again.

The air supply port 14a supplies air as an oxydant, which is supplied to the separators 15 at a constant pressure by the micro-blower 3 and reacts with the fuel. The air discharge port 14b discharges air containing CO₂ produced in the reaction between the air and the fuel both in the separators 15. The end plates 16a, 16b fasten the separators 15 by sandwiching them. The output terminals 33 output electric power generated in the fuel cell 1.

In FIG. 2, though the directions of the fuel supply port, the air supply port, the fuel discharge port and the air discharge port are shown, they may be freely changed in accordance with the structure of the fuel cell system. A method of fastening the power generation units after stacking them is conducted by screws in this embodiment; other fastening methods may be employed. For example, the stacked power generation units are placed in a casing under a pressure.

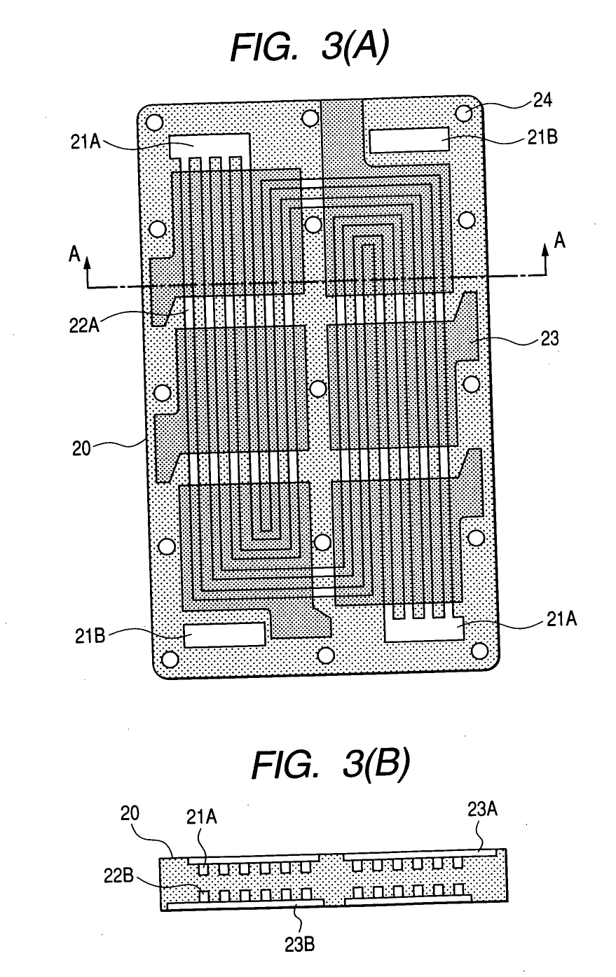

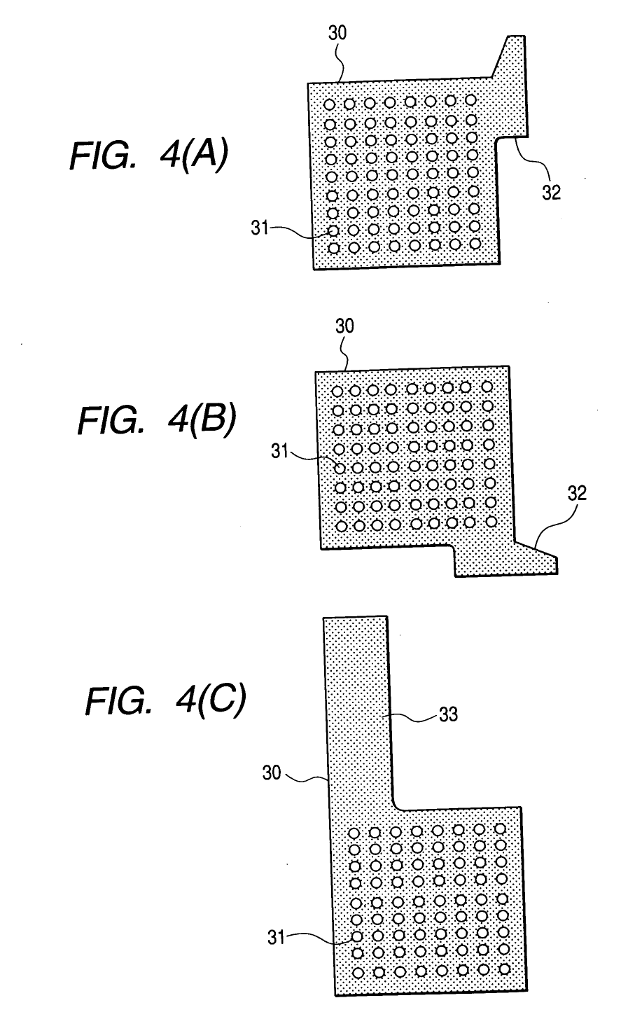

FIG. 3(A) is a plan view of a bipolar plate 20 for effectively circulating the fuel and air through the surfaces of the separators 15. FIG. 3(B) is a cross sectional view along the line A-A in FIG. 3(A). In FIGS. 3(A) and 3(B), the bipolar plate 20 is a plate form, and is provided with two inner manifolds 21A for introducing the fuel and two inner manifolds 21B for introducing oxydant gas (air) at both ends thereof. On one face of the bipolar plate, there are formed grooves 22A for distributing the fuel and recessed portions 23A having a desired shape. On the other face, there are formed grooves 22B for distributing air and the recessed portions 23B. The current collectors 30 shown in FIGS. 4(A), 4(B), 4(C) are placed in the recessed portions 23A, 23B. A depth of the recessed portions 23A, 23B is such that the top face of the current collectors 30 placed in the recessed portions 23A, 23B and the top face of the bipolar plate 20 become the same level, as shown in FIG. 3(B).

Through-holes 24 formed at positions with a certain interval in the bipolar plate 20 are used for fastening the stack.

The grooves 22A, 22B formed in the front face and the rear face of the bipolar plate 20 may be a serpentine structure as shown in FIG. 3(A), but any other structures such as parallel grooves or return flow structure that can distribute uniformly the fuel and air in the bipolar plate may be employed.

The bipolar plate 20 should have a smooth face on both side so as to bear the uniform pressure at the time of stacking. The plural fuel cell units should be electrically isolated from each other. Accordingly, materials for the bipolar plate are not limited as far as the unit cells are electrically insulated. The materials include high density polyvinyl chloride, high density polyethylene, high density polypropylene, epoxy resins, polyetherether ketones, polyether sulfones, polycarbonates or fiber reinforced resins of the above resins. As materials for the bipolar plate, carbon plate, steel plates, nickel plate, alloy plates, stainless steel plates such as chromium-nickel steels, intermetallic compound plates such as copper-aluminum, etc are surface treated with resin or coated with an insulating material.

FIGS. 4(A) to 4(C) show current contactors 30, which are placed in the recesses 23A, 23B formed in the bipolar plate 20. In FIGS. 4(A) to 4(C), the current contactors 30 are a plate form. The current contactors have different shapes as shown in FIGS. 4(A) to 4(C). That is, the current contactor 30 shown in FIG. 4(A) is provided with diffusion apertures 31A for diffusing the fuel supplied by the grooves 22A of the bipolar plate 20 and an inter-connector 32A for electrically connecting the adjoining fuel cells in the plane. The current collector 30 shown in FIG. 4(B) is provided with diffusion apertures 31B for diffusing the oxidant gas supplied from the grooves 22B formed in the bipolar plate 20 and an inter-connector 32B for electrically connecting the adjoining fuel cell unit in the plane.

The current collector 30 shown in FIG. 4(C) is different from the current collectors 30 shown in FIGS. 4(A) and 4(B) in that it is provided with an output terminal 33 instead of the inter-connector 32 in FIG. 4(A). Each of the current collectors is included in the unit cell.

If the shape of the unit cell is square, the current collectors shown in FIGS. 4(A), 4(B) have the same shape. Accordingly, if the shape of the unit cell is square, there are two types of shapes shown in FIGS. 4(A) and 4(C) in one plane of the bipolar plate; if the shape of the unit cell is rectangular, there are three types of shapes shown in FIGS. 4(A), 4(B) and 4(C) in one plane of the bipolar plate.

Materials for the current correctors 30 include, but not limited, a carbon plate, stainless steel plates, titanium plate, tantalum plate, steel plate, nickel plate, clad plate, etc. In metallic current collectors, electro-conductive portions of the current collectors may be plated with a corrosion resistance metal such as noble metals or may be coated with an electro-conductive carbon paint so as to lower the contact resistance of the members to improve an output and a long term performance stability of the fuel cell.

In this embodiment, the current correctors 30 are made of titanium, one face of which is plated with gold. The gold metal plate is at least 15% the total surface area of the current corrector 30, i.e. 15 to 40%.

The current collectors 30 are preferably bonded with an adhesive to the recessed portions 23A, 23B to form the flat surface with the flange portion of the bipolar plate. The adhesive should be insoluble to methanol or is not swollen to methanol and more stable electro-chemically than methanol. For example, epoxy resin adhesives are suitable. The current collectors 30 may be fixed to the recessed portions 23A, 23B by using the diffusion holes 31A, 31B or fixing holes and a projection that engages with the holes. It is not essential that the surface of the bipolar plate 20 and the surface of the current collectors 30 fixed to the recessed portions make the flat surface. If there is a step between the bipolar plate 20 and the current collectors 30, which may be fixed to the bipolar plate 20, a structure of a gasket may be changed to seal the step.

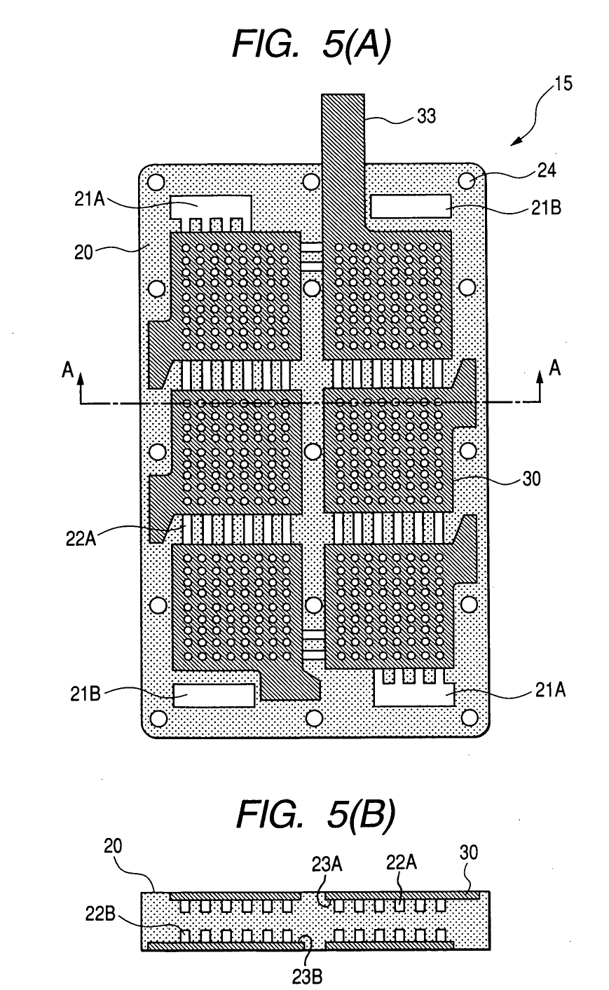

FIGS. 5(A) and 5(B) show a plan view of a separator and a cross sectional view along the line A-A in FIG. 5(A). The separator 15 is constituted by the method mentioned above using unit cells at positions corresponding to the current collectors, the bipolar plate 20 having the inner manifolds 21A, 21B and the current collectors 30. The inner manifolds 21A, 21B are four holes for introducing the fuel (methanol aqueous solution) and the oxidant (air). The bipolar plate 20 has grooves 22A, 22B for distributing the fuel and the oxidant on its both faces, the recessed portions 22A, 22B for fixing the current correctors 23A, 23B and holes 24 for fastening the separator at the time of stacking.

The current collectors 30 include the current correctors shown in FIGS. 4(A), 4(B) and 4(C).

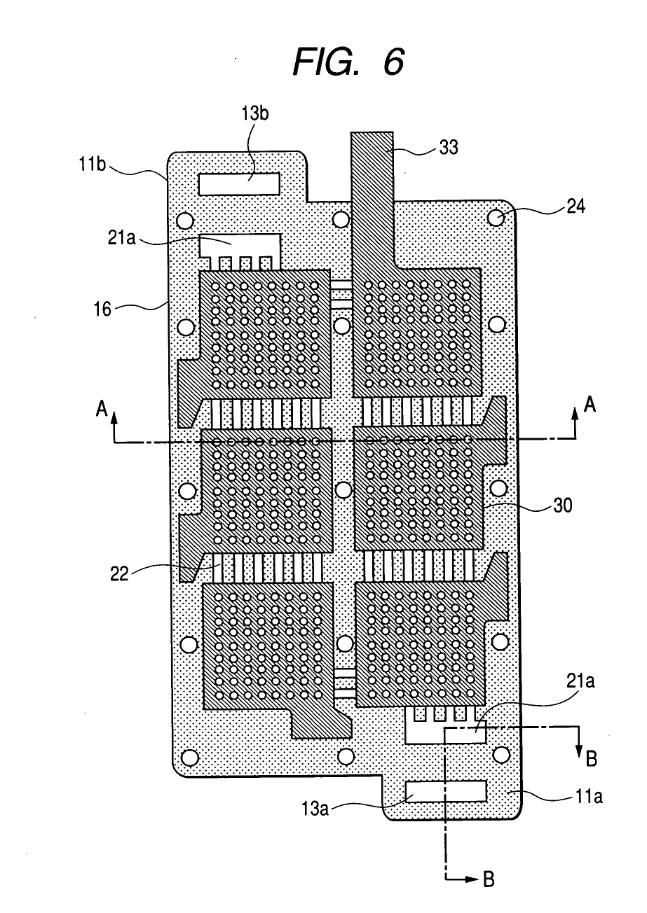

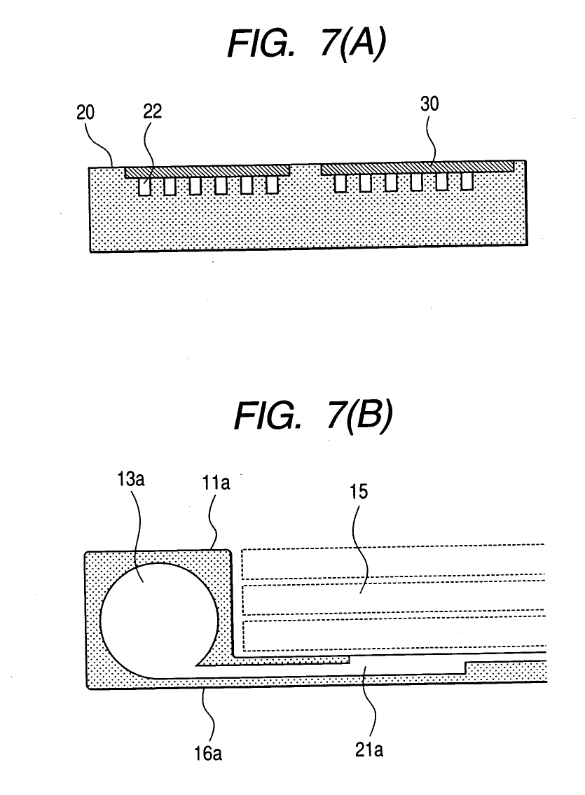

FIGS. 6, 7(A), 7(B) show a structure of an end plate. FIG. 6 is a plan view of the end plate, FIG. 7(A) is a cross sectional view along the line A-A in FIG. 6 and FIG. 7(B) is a cross sectional view along the line B-B in FIG. 6.

In FIGS. 6 and 7(A) and 7(B), the end plate 16 has two inner manifolds 21a for introducing the fuel or the oxidant on one face thereof. The inner manifold 21a does not penetrate the end plate but extend along the face thereof, as shown in FIG. 7(B). The end plate 16 is provided with grooves 22 for distributing the fuel and the oxidant on the inner face, the fuel supply manifolds 11a, 11b having a fuel supply port 12a or an oxidant supply port 14a shown in FIG. 2, a fuel discharge port 13b, air discharge port 14b shown in FIG. 2, manifolds 12a, 12b shown in FIG. 2, recessed portions 23A, 23B shown in FIG. 3(A) for fixing the current collectors 30 and fixing holes 24 for fixing the stack.

In this embodiment, the grooves 22, formed in the inner face of the end plate 16, for transporting the fuel or the oxidant have a serpentine shape. Other shapes for the grooves may be employed; for example, if a shape wherein the fluid makes return flow is employed, the inner manifold recessed portions 21a are disposed in the inner face of the end plate and the outer manifolds 11a, 11b are disposed at both ends of the end plate 16.

Materials for the end plates 16 should have a smooth surface so that a uniform pressure is applied to the stack, and should be electrically insulating so that unit cells arranged in a plane are electrically insulated. The materials are not particularly limited as long as the above conditions are satisfied. The materials for the end plates 16 are of high-density polyvinyl chloride, high density polyethylene, epoxy resins, polyetherether ketones, polyether sulfones, polycarbonates, or plastics reinforced with glass fibers. Carbon plates, steel plates, nickel plates, other alloy plates, intermetallic compound plates such as copper-aluminum, or stainless steel plates may be used. These plates are surface treated with inactivation treatment or with resins so as to be electrically insulated.

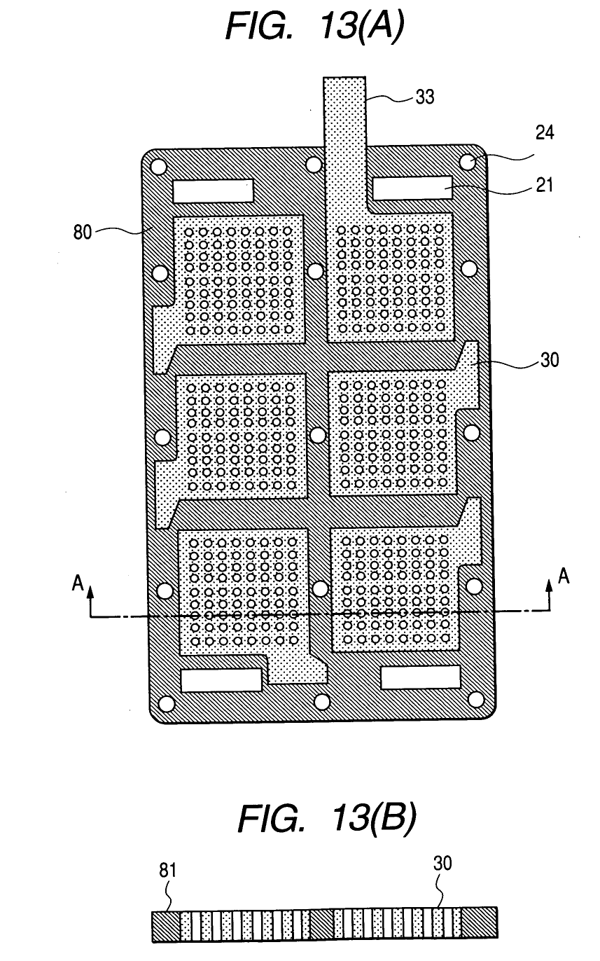

In another embodiment, the bipolar plate 20, which has no current corrector recessed portions 23 shown in FIG. 3(A) and a composite current corrector 80 are bonded to form the end plate 16, as shown in FIGS. 13(A), 13(B),

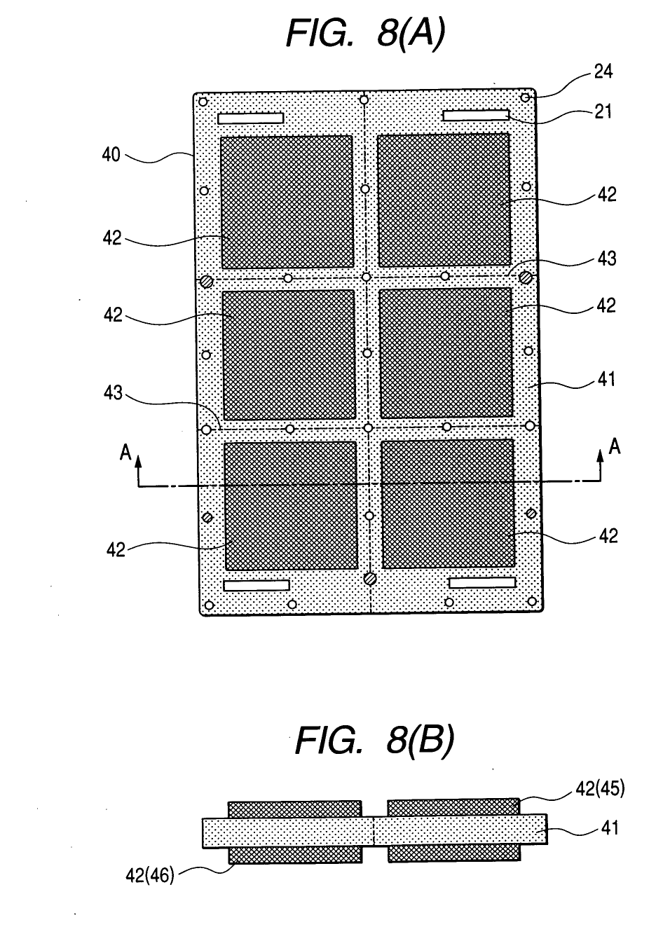

FIG. 8 shows an MEA 40 which has plural electrodes 42 bonded to both faces of the electrolyte membrane 41. The electrodes 42 are located at opposite positions on the both faces. The flange portion of the membrane has inner manifolds 21 for supplying the fuel and the oxidant and screw holes 14 for fixing the stack. Perforations 43 are formed between the electrodes.

The discontinuous perforations 43 have such connection strength that the MEA can be handled as a unit in assembling the fuel cell but have such cutting ratio that the connection of the electrolyte among the MEA is substantially prevented. The MEA 40 is provided with a pair of electrodes 42, one of which is the anode 45 and the other of which is the cathode 46, as shown in FIG. 8(B).

In the DMFC according to the present invention, the electricity is generated by directly converting chemical energy to electric energy by means of the electrochemical reaction shown in the following.

At the anode side, supplied methanol aqueous solution reacts to form CO₂, hydrogen ions and electrons, as follows, in accordance with the equation (1).
CH₃OH+H₂O→CO₂+6H⁺+6e⁻ (1)

The produced hydrogen ions H⁺ travel through the electrolyte membrane from the anode to the cathode; at the cathode, hydrogen ions react with oxygen diffused in the cathode from the atmosphere and electrons in the cathode to form H₂O, in accordance with the equation (2).
6H⁺+3/2O₂+6e⁻→3H₂O (2)

Accordingly, the overall chemical reaction for generation of electricity is shown in the equation (3), wherein methanol is oxidized by oxygen to form carbon dioxide and water, which is the same reaction as combustion of methanol.
CH₃OH+3/2O₂→CO₂+3H₂O (3)

An open circuit voltage of the unit cell is about 1.2 V; however, because of influence of permeation of the fuel through the membrane, an actual voltage of the unit cell is 0.85 to 1.0 V. Although not particularly limited, a range of 0.6 to 0.8 V is selected under a practically normal load operation.

Accordingly, when the fuel cell is used as a power source, the unit cells are connected in series so as to obtain a desired voltage in accordance with load devices. Though the output current density of the unit cell may vary based on the influences of electrode catalysts, electrode structures, etc, the fuel cell is designed to produce a desired current amount by selecting an area of the power generation section of the unit cell.

As the anode catalyst for the power generation section, there is a catalyst comprising mixed powder of platinum and ruthenium supported on a powder carbon carrier or a catalyst comprising fine particles of platinum/ruthenium alloy is supported on a carbon powder carrier. As the cathode catalyst, there is a catalyst comprising platinum supported on the carbon carrier. These catalysts are manufactured and used easily. A supported amount of platinum, which is the main component of the catalysts on the carbon carrier, is generally 50% by weight or less. If the dispersion of platinum on the carbon carrier is improved, even 30% by weight or less can provide a high performance electrode. An amount of platinum in the anode is preferably 0.5 to 5 mg/cm² and an amount of platinum in the cathode is preferably 0.1 to 2 mg/cm².

However, the amounts of anode catalyst and the cathode catalyst are not limited as long as the electrodes can be used in the ordinary fuel cells of the methanol direct type. The catalyst with high performance can save an amount of the catalyst, which leads to cost down of the power generation system.

If the electrolyte membrane is of hydrogen ion conductivity, it is possible to realize a stable fuel cell without receiving influence of carbon dioxide in the atmosphere. As the hydrogen ion conductive electrolyte membranes for MEA 40, there are sulfonated fluorine polymers such as polyperfluorostyrene sulfonates, perfluorocarbon type sulfonates, hydrocarbon type polymers such as polystyrene sulfonates, sulfonated polyetherether ketones, sulfonated polyetherether ketones or alkylsulfonated polymers.

If the polymers are used for the electrolyte membranes, the fuel cells can operate at a temperature of 80° C. or lower, in general. When composite electrolyte membranes containing hydrogen ion conducive inorganic compounds such as tungsten oxide hydrates, zirconium oxide hydrates, tin oxide hydrates, etc micro-dispersed in a heat-resisting resin or the sulfonated resin are used, the fuel cell can operate at higher temperatures. Particularly, composite electrolyte membranes using sulfonated polyetherether sulfones, polyetherether sulfones and the hydrogen ion conductive inorganic compounds are preferable because they are lower in methanol permeability than polyperfluorocarbon sulfonates. Electrolyte membranes with high hydrogen ion conductivity and low methanol permeability can improve a utilization rate of methanol for power generation, and can achieve compact fuel cells for a long term power generation.

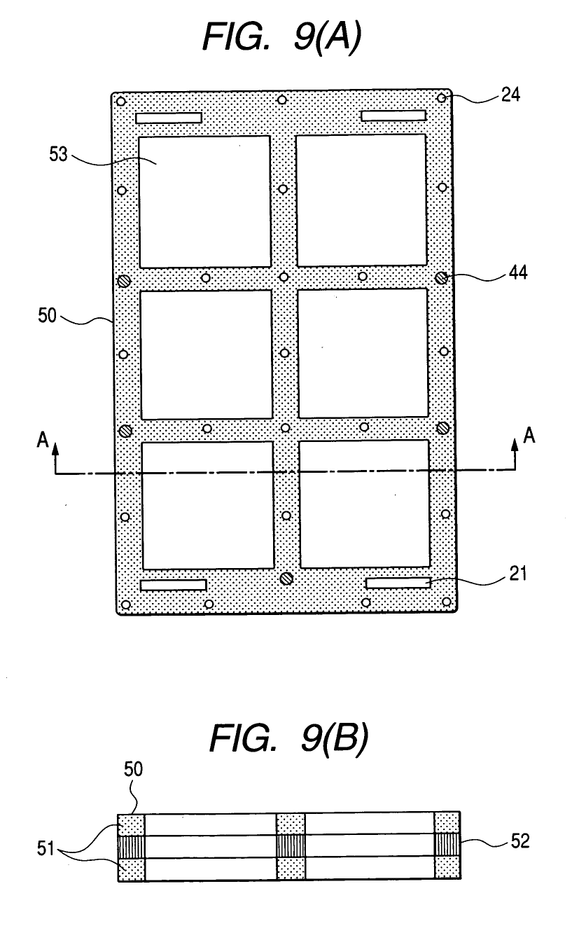

FIGS. 9(A), 9(B) show a plan view and a cross sectional view of a gasket 50 along the line A-A in FIG. 9(A), respectively.

In FIGS. 9(A) and 9(B), the gasket 50 has conductive windows, which penetrate the gasket and correspond to the MEAs 40, inner manifolds 21 for supplying the fuel and the oxidant and holes 24 for fixing the gasket 50. The gasket 50 seals the fuel supplied to the anode 45 shown in FIG. 8 and the oxidant supplied to the cathode 46 shown in Gif. 8. The gasket 50 is made of synthetic rubbers such as EPDM, fluorine-containing rubbers, silicone rubbers.

The gasket 50 comprises a high stiffness core member 52 and the elastic member made of the rubbers 51 so that the falling down of the electrolyte membrane 41 or the gasket 51 in the fluid distribution grooves formed in the bipolar plate 10 is prevented. As a result, crossover of the fuel and the oxidant by the falling down is prevented. Thus, the lamellar gasket, which is a laminate structure of the core member 52 and the gasket layers 51, is an effective means for increasing reliability of sealing.

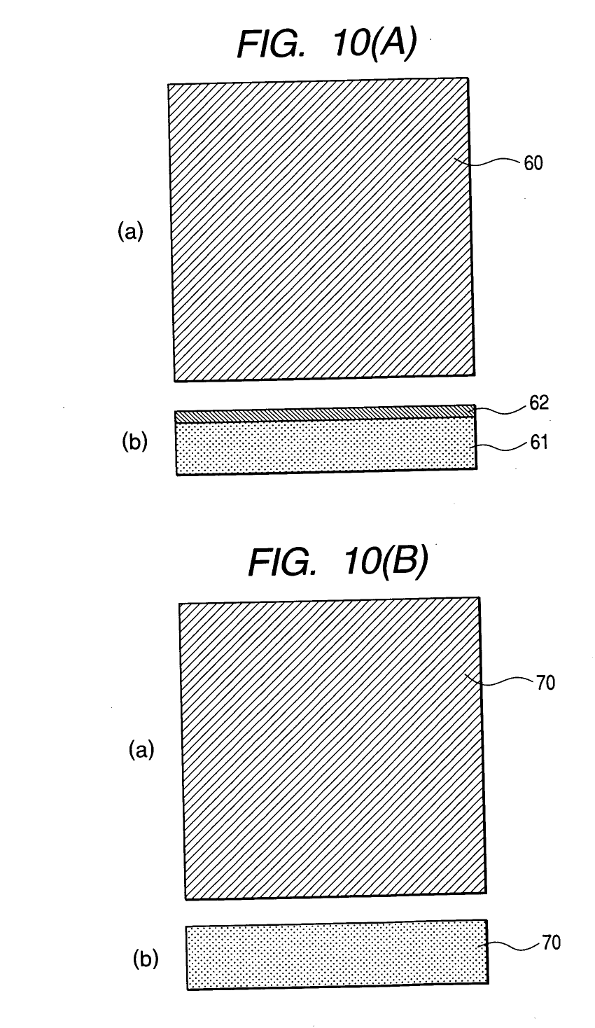

FIG. 10(A) shows a cathode diffusion layer 60 and FIG. 10(B) shows an anode diffusion layer. In FIG. 10(A), a plane view of the cathode diffusion layer is shown in FIG. 10(A) (a), and a cross sectional view of the cathode diffusion layer is shown in FIGS. 10(A) (b). In FIG. 10(B), a plan view of the anode diffusion layer is shows in FIG. 10(B) (a) and a cross sectional view of the anode diffusion layer is shown in FIG. 10(B) (b).

In FIG. 10(A), the cathode diffusion layer 60 comprises a water repellent layer 62 and a substrate 61. The water repellent layer or hydrophobic layer 62 is laminated with the substrate so that the water repellent layer is in contact with the cathode electrode 46.

The surface contact between the anode diffusion layer 70 and the anode electrode 45 is not particularly limited. As the substrate 61 for the cathode diffusion layer 60 is made of an electro-conductive porous material.

Generally, the substrate 61 is made of carbon fiber-cloth or non-woven cloth, such as TORAYCA fabrics (carbon cloth) manufactured by Toray Corp. or TGP-H-060 (carbon paper) manufactured by Toray Corp. The water repellent layer 62 may be made by mixing carbon powder and water repellent fine particles, water repellent fibril or water repellent fibers such as polytetrafluoroethylene. More concretely, carbon paper is cut into desired pieces and water content of the pieces is measured. Then, the pieces are dipped in a polytetracarbon/water suspension liquid (D-1: manufactured by Daikin Industries) having such a concentration that a final concentration of the carbon paper after baking is 20 to 60% by weight. Thereafter, the carbon paper is drier at 120° C. for one hour, and the carbon paper is baked in air at 270 to 360° C. for 0.5 to one hour, thereby to impart water repellency to the carbon paper.

Then, carbon powder (XC-72R manufactured by Cabot Corp.) and 20 to 60% by weight of polytetrafluorocarbon/water suspension are kneaded. The kneaded paste is coated on one face of the water repellent carbon paper at a thickness of 10 to 30 μm. The coated carbon paper is dried at 120° C. for about one hour, and the dried carbon paper is baked in air at 270 to 360° C. for 0.5 to one hour to produce the cathode diffusion layer. The air-permeability and humidity-permeability of the cathode diffusion layer 60, i.e. diffusion performance of the supplied oxygen and produced water largely depend on an additive amount, dispersion and baking temperature of polytetrafluoroethylene. Therefore, the conditions are selected in considering the design performance, operation circumstances, etc of the fuel cell.

In FIG. 10(B), the anode diffusion layer 70 is made of carbon fiber woven cloth or non-woven cloth. For example, carbon fiber woven cloth is carbon cloth (Treca cloth) or carbon paper (TGP-H-060) are preferable materials. The anode diffusion layer 70 functions as to supply the aqueous fuel and to quickly release carbon dioxide. Therefore, dispersion of hydrophilic resins or titania having strong hydrophile property in the carbon porous substrate is an effective method for increasing an output of the fuel cell.

The materials for the anode diffusion layer 70 are not limited to the ones mentioned above. The materials that are inert to electro-chemical reaction include metallic materials such as stainless steel fiber non-woven cloth, porous body, porous titanium, porous tantalum, etc.

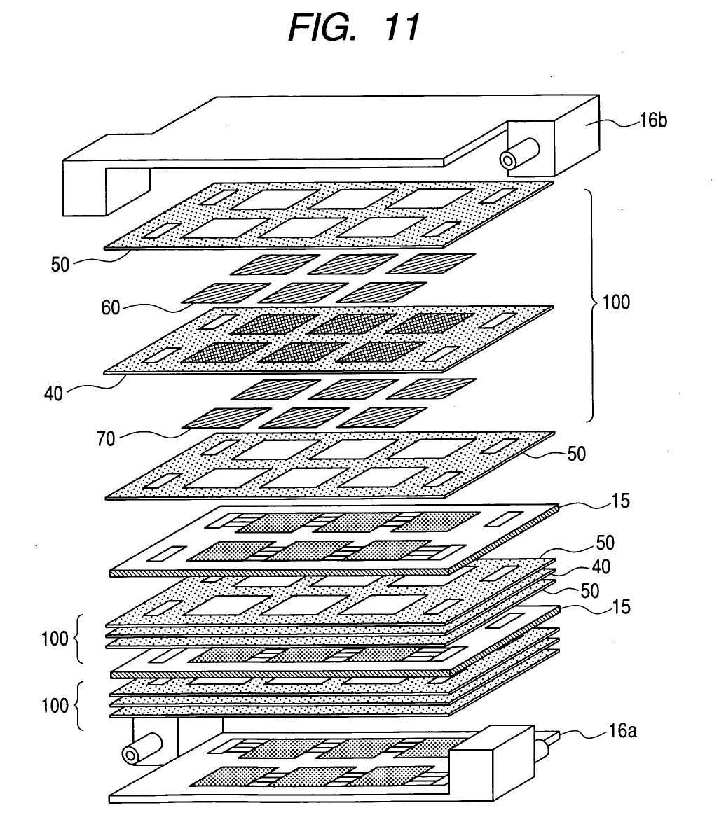

FIG. 11 is a developed view of the fuel cell according to the present invention. In FIG. 11, the fuel cell unit 100 is constituted by the cathode end plate 16b, the gasket 50, the cathode diffusion layer 60, MEA 40, the anode diffusion layer 70 and the gasket 50. The fuel cell units 100 are stacked by means of the separator 15 as shown in FIG. 11. After stacking the units, the anode end plate 16a is stacked.

### Embodiment 2

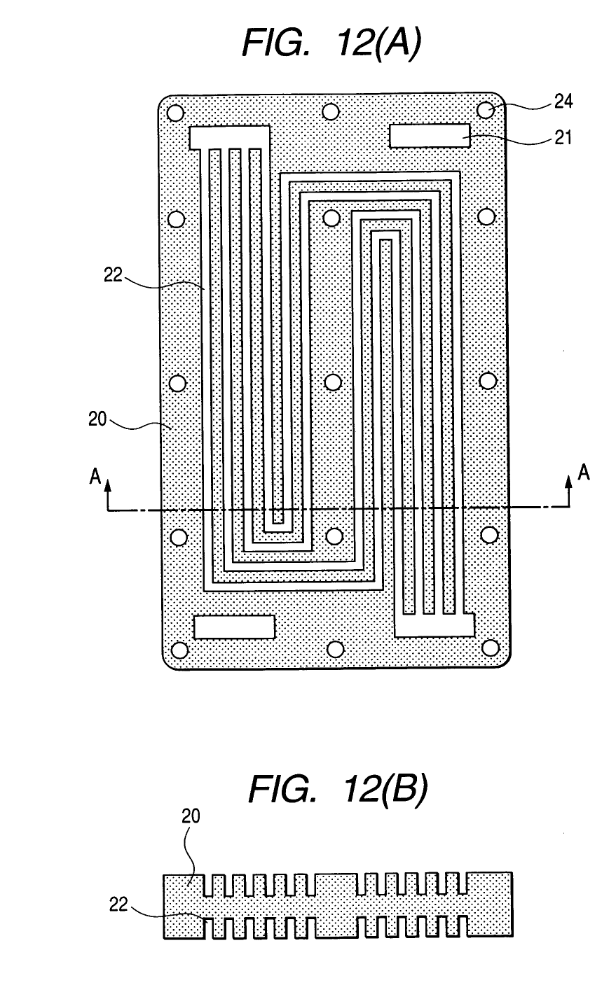

FIGS. 12(A) and 12(B) show a plan view and a cross sectional view of another embodiment of the present invention. In FIGS. 12 (A), 12(B), the bipolar plate 20 has no recessed portions where the current collectors are embedded. In this case, the bipolar plate 20 has four manifolds 11, the grooves 22 for distributing the fuel and the oxidant and through-holes 24 for screws for fixing the stack.

On the other hand, as shown in FIGS. 13(A), 13(B), a composite current collector 80 is constituted by current collectors 30 and the current collector frame 81. The separator 15 is constituted by the composite current collectors 80 and the bipolar plate 30 sandwiched between the current collectors 80.

In the DMFC comprising a fuel cell constituted by stacking unit cells each of which comprises the gasket, the cathode diffusion layer, MEA and the anode diffusion layer, the output power is monitored by the controller during the operation and stopping of the fuel cell, and the output power is supplied to a load device by means of an output terminal. The output power that is supplied from the terminal to the load device may be supplied after it is converted by the DC/DC converter, and the potential is elevated.

The unit cells formed in the fuel cell are separated into plural units in a plane of the separator and the plural cell units are connected in series.

The gasket for DMFC has plural windows for conduction portions corresponding to the MEAs, the gasket comprising a stiff core member and elastic sheets on both faces of the core member. The elastic member may be made of synthetic rubbers, fluorine-containing rubber, or silicone rubber.

The cathode diffusion layer may be constituted by a water repellent layer and an electro-conductive porous material. The porous material may be carbon fiber woven cloth or non-woven cloth. The water repellent layer can be constituted by carbon powder and water repellent fine powder, water repellent fibril or water repellent fiber.

The MEA uses the electrolyte membrane; the membrane is divided into several sections each of which has electrodes bonded to both faces of the membrane and has inner manifolds for supplying the fuel and the oxidant in the flange portions. The discontinuous cut portions such as perforations may be formed between the electrodes.

The anode diffusion layer may be constituted by the current collectors, which are made of electro-conductive porous carbon fiber and substantially electro-chemically inactive metal material. 15 to 40% of the surface of the current collector may be plated with gold.

The separator plate may have 4 manifolds for introducing the fuel and the oxidant in the both ends thereof. The grooves for distributing the fuel and the oxidant are formed in the inner face thereof and the recessed portions for fixing the current collectors are formed in the both faces thereof.

The end plates of DMFC are provided with two recessed inner manifold portions for introducing the fuel and the oxidant in one face thereof. The end plates are further provided with the manifolds having the fuel supply port, the oxidant supply port for supplying the fuel and the oxidant, and the fuel discharge port and the oxidant discharge port for discharging the fuel and the oxidant. The end plates are still provided with the recessed portions for fixing the current collectors.

What is claimed is:

1. A fuel cell, which comprises a plurality of fuel cell units each comprising an anode for oxidizing fuel, a cathode for reducing oxygen, a membrane/electrode assembly sandwiched between the anode and the cathode, wherein the fuel cell units are arranged in a plane to constitute power generation unit, a plurality of the power generation units being stacked by means of insulating plates.

2. The fuel cell according to claim 1, wherein the electrode/membrane assemblies of the unit cells are connected in series in the plane.

3. The fuel cell according to claim 2, wherein connection of the adjoining electrode/membrane assemblies is performed by means of current collectors.

4. The fuel cell according to claim 2, wherein the stacked power generation units are electrically connected in series.

5. The fuel cell according to claim 3, wherein the stacked power generation units are electrically connected in series.

6. An information terminal, which comprises an information terminal device on which a fuel cell is mounted, the fuel cell comprising a plurality of fuel cell units each comprising an anode for oxidizing fuel, a cathode for reducing oxygen, an membrane/electrode assembly sandwiched between the anode and the cathode, wherein the fuel cell units are arranged in a plane to constitute power generation unit, a plurality of the power generation units being stacked by means of insulating plates.
